(19) United States
(12) Patent Application Publication
(10) Pub. No.: US 2007/0073934 A1
(43) Pub. Date: Mar. 29, 2007

(54) Method, system and computer program for displaying information

(76) Inventor: Susan Louisse Rogers, Nelson (NZ)

Correspondence Address: BIO INTELLECTUAL PROPERTY SERVICES (BIO IPS) LLC, 8509 KERNON CT., LORTON, VA, 22079, US

(21) Appl. No.: 10/574,019

(22) PCT Filed: Oct. 6, 2004
(86) PCT No.: PCT/NZ04/00243

§ 371 Date: Mar. 29, 2006

(30) Foreign Application Priority Data
Oct. 6, 2003 (NZ) 528707

(51) Int. Cl. G06F 3/00

(52) U.S. Cl. 710/59

(57) ABSTRACT

This invention relates to a computer program for displaying information in the form of a display window during a downtime when a computer user is waiting for a computer to complete processing tasks, and referred to herein as a wait event, the program including the steps of detecting await event and activating an information datafile or information (a) or activating the program manually by the user; displaying information on a computer monitor in the form of data and/or graphics and/or video and/or audio material (b); and suspending the program when the wait event has ended or when suspended manually by the user (c), such suspension resulting in the disappearance of the display window.

### TECHNICAL FIELD

This invention relates to information generation and displaying systems and methods. More particularly, but not exclusively, the present invention relates to a computer software program and associated systems adapted to generate and/or display information when a computer may be instructed to undergo substantial processing tasks rendering a certain amount of time dedicated to the processing task, and this time period may also be utilised by the program of the invention until the processing task has been completed.

### BACKGROUND ART

Personal computer users often experience “down time” when a computer is in the process of carrying out tasks such as, for example, loading applications, waiting for data or webpage content to be downloaded from the internet, starting or closing the operating system, virus checking, fetching documents or data, printing, or other processing activity or activities causing a wait event with a computer. With many computer applications, the hourglass icon appears as a symbol of the computer being busy with processing tasks, or there is a display of an application-specific static or dynamic icon indicating activity. In other programs a pop up window may display the message “please wait”. The amount of time that can be cumulatively wasted during such wait events can be significant.

One type of website advertising utilises a banner advertisement whereby a pop-up window appears during viewing of a website page. Such advertising is considered an intrusion to most viewers as the pop-up banner or window can obscure the webpage being read or viewed. Generally viewers dismiss such advertising banners and quickly close such windows because the intrusion is a distraction from reading or viewing content on the webpage, and due to the lack of control over the subject matter of the advertising information being delivered.

It is a non-limiting object of the invention to provide a computer program for displaying information and/or text and/or graphics and/or audio and/or video and/or various RSS feeds and the like on a computer monitor at intervals when the computer is otherwise processing, that overcomes at least some of the abovementioned problems or at least to provide the public with a useful choice.

It is a further non-limiting object of the invention to provide a computer program for generating and displaying information on a computer monitor at intervals when the computer is otherwise processing, that overcomes at least some of the abovementioned problems or at least to provide the public with a useful choice.

### SUMMARY OF THE INVENTION

According to a non-limiting aspect of the invention there is provided a computer program for displaying information in the form of a display window during a downtime when a computer user is waiting for a computer to complete processing tasks, and referred to herein as a wait event, the program including the steps of:
A. detecting a wait event and activating an information datafile or information or activating the program manually by the user;
B. displaying information on a computer monitor in the form of data and/or graphics and/or video and/or audio material; and
C. suspending the program when the wait event has ended or when suspended manually by the user, such suspension resulting in the disappearance of the display window.

Preferably the computer program further includes the preliminary step i. of selecting user preferences, including any one or more of the following preferences, being the type of information for display as a window; the duration of the window of information for display; the number of windows; the size of the window; the contrast background of the window; the transparency level of the background of the window; and the colour of the window.

Desirably in step c. the program is suspended, and further comprising step d. of resuming display of the information datafile when a further wait event is detected.

Advantageously the program is configured to recommence at the point where it was suspended at the ending of the wait event, and continuing with step b. until step c. reoccurs.

Preferably the computer program further includes step e. of loading a second information datafile for display after the first information datafile has been displayed or when the user chooses to load the second or a subsequent information datafile.

Desirably the preliminary step i. includes preselecting any one or more information datafiles from a library of datafiles, the datafiles comprising information and/or text and/or graphics and/or audio material in a format suitable for display on a computer monitor.

Optionally in step b. the time period for display of information in a window before the next frame is shown is automatically adjusted given a user's reading speed and the amount of information being presented during a wait event.

Preferably the information provided for display in step b. is obtained from a RSS feed and cached on a computer hard drive for presentation in a display window at a subsequent wait event.

Desirably the time interval between receipt of updated information from a RSS feed by a computer is automatically adjusted based on recent changes to content in the information being received by the RSS feed.

Advantageously in step b. queries for details of updated information relating to the RSS feeds are regularly sent to internet based computer web servers, and such queries are monitored and the queries rate is adjusted based on the threshold of intrusion on the network bandwidth applying to the computer.

Preferably the program is adapted to provide a means to search for information on particular goods and/or services specified by a user through the RSS feeds, and the search means is adapted to communicate with an internet based search engine.

Preferably in step i. a user can select an origin point for anchoring a corner of the display window, the origin point of the display window being the corner of the display window that is nearest to a corner of the desktop of the computer monitor.

Preferably in step b. the information datafile includes information prepared as a sequence of questions and associated answers on a particular subject, and wherein a set of questions and answers on a subject form an information datafile.

Optionally the number of questions and/or the degree of difficulty of the questions and/or the sequence of display of each said question and associated answer from each said information datafile is selectable by a user.

Desirably each selected information datafile is displayed sequentially or randomly.

Preferably the window display is adapted as a personal notepad for display on a computer monitor to allow a user to upload data or information onto the personal notepad to generate a digital personal note, and the digital personal note is stored for later display at a predetermined future date and time as a reminder, or displayed during a wait event.

Preferably each said personal note generated is assigned a file category, and each said personal note and each said file category is retrievable and updateable.

Preferably each said file category is assigned a different colour to distinguish one category of said personal note from another category.

Desirably a print function and an archive function are provided for each said personal note.

Optionally the program is adapted to allow a user to encrypt and lock access to particular information datafiles and particular RSS feeds to only authorised users of such information datafiles.

### BRIEF DESCRIPTION OF THE DRAWINGS

Preferred embodiments of the invention will now be illustrated, by way of example only, with reference to the accompanying drawings in which:

FIG. 1: Shows a flow chart of processing steps of a program for use in displaying information during wait events on a computer; and

FIG. 2: Shows a flow chart of processing steps of a routine in the program for use in displaying information during wait events on a computer.

### DETAILED DESCRIPTION OF THE DRAWINGS

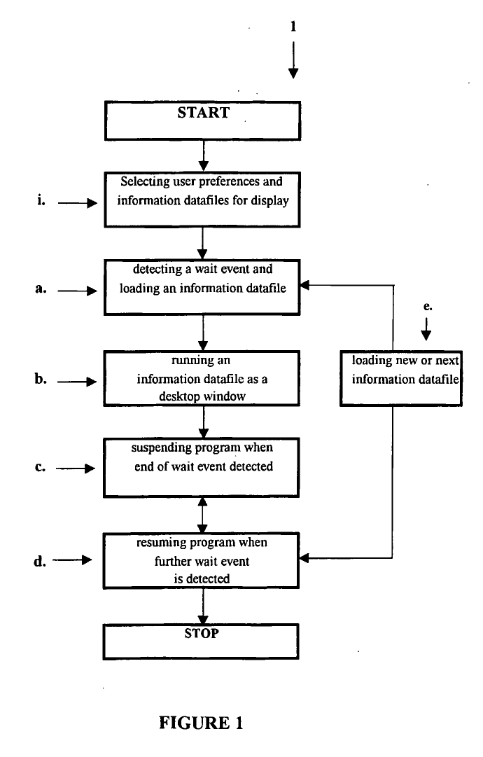

Referring to FIG. 1, a flow chart of a computer program, generally referred to as 1, according to a preferred embodiment of the invention, is illustrated.

Even with personal computers evolving to run faster applications, it is considered that there will still remain significant periods of time when a computer is busy with processing tasks rendering a “downtime” for a computer user. Such computer “downtime” can result in a period of inactivity for the user. During such periods, a user may waste time by watching the hourglass symbol on the screen or otherwise. Instead, a computer user may choose to use the “downtime” to run the computer program of the invention developed to advantageously educate, inform and/or desirably entertain a computer user during such periods of time.

According to the invention there is provided a computer program 1 configured and arranged to preferably operate as an application on a computer during the “downtime” encountered from time to time with computer use and associated peripherals, and referred to herein as a “wait event”. Once running, the program 1 of the invention includes step a. wherein the program will detect a “wait event” or wait condition. The “wait event” may include, but is not limited to, an hourglass cursor or other cursor as preferred by a user and as installed on the computer, or a display of an application-specific static or dynamic icon indicating activity. The cursor indicates that the computer is executing a command or that the computer is in a “busy” state, such as, for example, activity involving the installation of software. Other delay episodes or “wait events” can include time periods when a “Please Wait” message in a pop up window appears, for example, when a program is being run or a file is being loaded, or when a user is connecting to a remote server via a modem, or when a document is being printed, or during virus checking routines, or during data back up routines or during logging on operations and delays generally encountered when internet browsing.

Further, and by way of non-limiting example only, a wait event can include any event associated with the operation of a computer/CPU such as defragmenting a hard drive, scanning, booting up, logging on, logging off, printing, virus scanning or cleaning, internet connecting, web browser use, and can also include any event associated with a peripheral device such as, for example, a printer, scanner, facsimile, telephone, second computer and network action, and any other delay event associated with computer use.

It is envisaged that the program 1 may be alternatively configured to operate as an alternative to a screen saver program running on the desktop of a computer.

Additionally, the program 1 may be run as a result of a user-driven event in the form of a predetermined “scheduled event” such that the computer program can occur simultaneously with the operation of any other computer program or during any predetermined time that the computer is in operation.

Once step a. has occurred, the program loads an information datafile and then executes step b. with using the downtime encountered or predetermined event to load and run a desired library of information or datafile or other such file broadly referred to hereinafter as a “datafile”. The “datafile” may include, but is not limited to, displaying information and/or data and/or graphics and/or sound in the form of wave files and the like, and/or video files, and/or RSS feed (“really simply syndication”) on a computer monitor.

A datafile can include a plurality of “snippets” of any desirable quantity. A “snippet” is a term given to a unit of information, text, video, graphics, sound and/or any combination thereof. In a non-limiting example of a snippet, it may comprise any computer user provided materials or be provided externally and optionally via a RSS feed. Commonly it may be provided in the form of a quotation, and a datafile may include any possible number of snippets in a datafile of quotations. A common form of snippet may include graphics in the form of personal photo images, and such images may be accessed via a database of photo images directly from a computer hard drive or supplied indirectly via a website over the internet.

The types of information datafiles that may be configured and arranged for display include subject matter having an educational, entertainment and/or recreational purpose. Some examples of information datafiles include dictionaries, language learning, famous quotes in desired categories such as politics, philosophy, economics, social, religious or otherwise, jokes, anecdotes, religious verses, almanacs, encyclopaedic categories (such as sporting facts in a selected group, world records, travel or geographical facts, historical facts, art history or artwork in a variety of selected groupings, and any other desirable categories), cooking recipes and tips, medical aids or remedies, stock market information or tips, news events or news history, or any other desirable information and/or data and/or graphics and/or any computer user provided materials. Further, real time steaming information, such as news updates, stock market data quotes, weather, and cartoons can be provided live via internet websites using RSS/XML file standards.

The information datafiles can be used as a teaching tool. These particular information datafiles includes information prepared as a question on a particular subject of interest, such as, for example only, standard learning disciplines as mathematics, science and languages, and/or general knowledge-type questions on subjects such as sport, politics, science, geography or geology. The program can be desirably configured to allow the answer to the question to follow sequentially through a set of questions on any selected subject from an information datafile.

This type of information datafile can include any desirable number of questions on the subject. Further, the degree of difficulty of each question or sets of questions can be selected, Furthermore, the program 1 allows a user to select the sequence of display of each said question and associated answer from each said information datafile in that the order of display of each stack or set of questions and associated answers can be reviewed and selected by a user.

The libraries of information or datafiles may be advantageously encrypted and locked to a specific user's computer preferences on the computer. This may be particularly useful in applications whereby a user is reviewing and managing commercially sensitive information whereby access to third persons is restricted.

In one embodiment, the datafile may be configured to display multiple information in “block” calendar form for each day of the year, the blocks each having selectable categories such as weather information, a quote, foreign language instructions, or any of the information itemised above under educational and recreational programs and programs for entertainment. It may well be that at least two desktop display windows are devised to simultaneously display the desired information or data and the like during step b. of the program. Typically for each day a quote of the day and information on the day in history may be displayed.

Alternatively other types of files can be run during the predetermined period in step b. include mpeg or wave files or video-type files displaying movies, short films, comedy, music videos or websites using RSS/XML file standards and the like. Additional functionality of the program of the invention preferably includes the facility to display computer user generated graphics, and/or text, and/or video, and/or audio and the like.

Preferably the program 1 includes the preliminary step i. of selecting user preferences for the program and with preselecting information datafiles for display by the program 1 when a wait event has been detected. Desirably the preselection can include datafiles on a variety of subject matter and interests.

It is envisaged that such data or displayed information or otherwise will run for the period of the wait event. In accordance with step c. the program is suspended when the end of the wait event has been detected. During this step the window may fade out or be minimised or hidden from view until the next wait event is detected or the program closed.

Desirably, step d. of the program is configured to resume or continue the program 1 to display the window again when a further wait event has occurred. Advantageously the program 1 may recommence at the point of the datafile or other file at the point at which it was suspended during the previous end of the wait event, and to continue with step d. until step c. occurs or the information datafile has shown its store of information, in which situation step e. may preferably be activated to load a new information datafile for viewing by a user.

It is envisaged that the program 1 will be adapted such that step d. will not occur if the duration of the wait event is too brief or short and that the user preferences can include a predetermined minimum time period to determine if the wait event will be long enough to allow the user to see the displayed material during the predetermined wait event.

In one non-limiting embodiment the datafile may run sequentially through each item or frame for display until all the items are displayed, and then may desirably repeat the sequence from the first frame to the last frame. The items or frames may comprise any desirable number, and may be collated, organised and stored to display predetermined snippets for each day of the calendar year with relevant information for each day such as, for example, an event on the same date in history. The snippets can be tagged with the date they are to be displayed on.

It is envisaged that a datafile may be configured and arranged to comprise any number of snippets. Alternatively, the program may be configured to randomly select and display simultaneously any possible number of snippets of information from any number of information datafiles.

The information datafile may comprise thousands of snippets of information for display and therefore each wait event can display information continuously for a significant period of time. It will be seen that the program 1 can be configured and arranged to allow any suitable and desirable period of time for display of a snippet, as desired. Desirably the user preferences in the program allow a minimum and maximum time settings to be applied, and the usual settings may well be between 5 and 15 seconds before the next snippet or item is viewed. The program 1 can also preferably automatically adjust the display time to a user's reading speed and given the amount of material being presented.

The program 1 is adapted to include user functionality desirably in the form of selectable user preferences as previously referred to as step i. in the program. Such set up preferences preferably includes the time in seconds that the snippet will remain visible after a wait event is detected, and selecting the information datafile(s) from the list or library of information datafiles available, such information datafiles providing the type of information a user wishes to receive during “wait events”. Alternatively, or additionally, a user may select information feed from a website or from an external source from the internet. Further description on information datafiles or information for display is detailed below with reference to step e. although it will be seen that in step e. imported information from any source via the internet, a local or remote network, databases, servers or otherwise may be fed into the program 1 of the invention.

User preferences may desirably include selecting the mode of application and such modes, in one non-limiting application, may include a calendar mode whereby snippets are displayed by being date stamped to a particular date such as an event on that day in history; a random mode whereby any snippet may be displayed on any one day and/or a snippet is repeated throughout one day and/or one snippet is repeated a set number of times per day and/or a selectable number of snippets are displayed for any one day; a display mode whereby a datafile can be selected and displayed as required; and a screen saver mode allowing the program 1 to run as a screen saver.

User preferences include those relating to the window for display on a desktop of a computer monitor. Such preferences desirably include, but are not limited to, selectable options for the font size for text, background, size, level of transparency and contrast of the background, colours and/or pattern of the window for display of information. Such preferences can be customised given the display resolution and screen size available on the particular computer to which the program 1 will be active. The transparency of the window can be selected depending on the degree of visual impact required for the display window.

The program 1 includes preferences for the origin point or position of the window for display on the desktop of the monitor. It is seen that a user can choose the origin point of the window for display that can desirably be at any point of a user's display screen or computer monitor. Once the position is chosen, the corner of the snippet display window closest to a corner of the computer monitor will become the anchor point. All snippet windows subsequently displayed will emerge from the anchor point in a cluster. This feature can eliminate the visual effect of windows for display of snippets from seemingly jumping around the screen of a computer monitor when differences in format and dimensions change.

It is envisaged that the information for display can include overlaying more than one file type, and therefore it is considered that the display of multiple layers of data and files may be advantageous for some users requiring a denser display of information at any given time during operation of the computer.

Once a wait event has been detected in step a., a preselected information datafile is loaded, and step b. of the program operates with the information datafile being run to display information, data, graphics, audio and/or video on a user's computer monitor or monitors as a graphic window. The information can be displayed for as long as the wait event continues or when manually closed or suspended by a user. When the wait event ends due to the completion of a computer processing task or otherwise, the program is suspended in accordance with step c. of the program. During step c. the display will disappear in a way that is acceptable by a user, whether by a gradual fade or immediate disappearance or otherwise, and the user may continue with working on processing tasks for the computer.

In accordance with step d. of the program, the program will resume displaying a window of information or otherwise when a further wait event has been detected and the computer is busy again with processing tasks.

Once a particular datafile has completed displaying information, or otherwise as desired, in accordance with step e. the next information datafile, or a further new information datafile, is run on display. It is seen that step e. of the program allows for new information or data to be fed through to the graphic window from an external source from the computer to which the program 1 is loaded, such as, for example, via a web server or other internet source. This information may advantageously include selectable subject matter such as, for example, news headlines, the latest sports news, commentaries and scores, appointment reminders, live news updates fed from a chosen news website, or from a specifically designed and configured website to feed updates of information to users of the program 1.

The information delivered to a user of the program 1 may be preferably provided via syndication desirably in the form of a “really simply syndication” (“RSS”) feed or any other source for information, text, audio, video, and including movie files. It is seen that the RSS feeds provide text (for example XML format files) and such feeds are ideally provided for updated information on subjects of interest. The RSS syndication allows a user to subscribe to a particular website, and obtain their preferred information in the form of text in this instance, and have such text downloaded and cached on the computer hard drive and polled ready for display on the computer monitor at the next wait event or when desired.

It is envisaged that the program 1 will allow a user to select a particular RSS file from a website and download such files at intervals, including links to websites if further details and information is required by a user. It is envisaged that this technology can be incorporated fully into the functionality of the program 1. The downloaded RSS files and other information from any imported source onto a computer hard disk can be arranged into readily accessible folders for storage and retrievable purposes, and can later be archived or deleted as required. Furthermore, downloading RSS files can be tagged a slow priority on the network and undertaken during periods when network traffic is minimal or below a certain threshold level to ensure network bandwidth is not unduly restricted.

The program can be adapted such that the time interval between receipt of updated information from a particular RSS feed by a computer is automatically adjusted based on recent changes to content in the information being received by the RSS feed. Further, queries for details of updated information relating to RSS feeds are regularly sent to internet based computer web servers, and such queries are monitored and the queries rate adjusted based on the threshold of intrusion on the network bandwidth applying to a program user's computer.

It is considered that information from various RSS feeds and other sources for information and digital data and media, including movies, can be desirably prioritised with precedence given to certain types of RSS feeds or specific items, for example only, in the case of a breaking news item or high priority broadcast messages, those items can be forced to be shown first at the next wait event, or a subsequent or future wait event, or a scheduled event, as prioritised by the program user.

The information cached on a user's computer hard disk via an RSS feed or other automatic file download of choice can then be displayed at a subsequent wait event. If there is not enough time to display all the information cached it can be further stored and displayed subsequently. An advantage of caching information is that some downloaded files are large, such as video or movie files, and it may take time for the complete file to be downloaded. Therefore, the file may be broken up into a number of data packets of information relating to a large file may be sent via the internet to complete the file download over time, and such downloading of data packets may be staggered depending on demands on network bandwidth. In such instances the downloading of such large files may well be defined as low priority to ensure it has minimal impact on network bandwidth.

The program 1 is preferably configured such that information may be saved on a computer network on a separate computer or stored offsite when the computer to which the primary program is loaded is offline, and then downloaded to the primary computer's hard drive when it is back online.

It is considered that in the case of news feeds, the program 1 may be configured to delete any information cached and stored but not displayed if it has not been able to be displayed within a predetermined period of time such as 2 days. This can reflect a preference for only displaying new information rather than old and obsolete information. In some instances, old information such as stock market data would be obsolete if not viewed within a period of time and therefore shorter periods for deleting old information may be desired. The user preferences in step i. can include such time periods for cached information.

The functionality of this aspect of the invention reflects the value in preselecting subjects of interest to a user, and such information can include trading commodities and any product or service of interest to a user. For example, if a user decides they wish to purchase a new product, or art works of a particular category, or a DVD of a latest movie, they can preselect the category of information, and during subsequent wait events, information can be displayed. Such information may be in the form of bids from an auction website or from websites selling items of interest.

In the case of rare art works, a standing instruction on an RSS feed to supply any information of particular art works for sale may be provided, thus a user can receive only relevant information on the art works of interest rather than receive what they may consider as intrusive information commonly referred to as “spam” referring to unsolicited information being sent over the internet to a computer user.

It is envisaged that the program of the invention in step e. or otherwise would be adapted with search engine functionality so as to run searching routines over the internet to locate goods and services of particular interest to a user of the program 1. It is further envisaged that the search engine may only search on selected websites, and collate and display the results of the search in a window display during a wait event or otherwise as preset or desired. For example, if purchase times are important as they can be with auctioned items, any change in the bid price may be communicated to a flashing display window immediately or it may be displayed during the next wait event detected.

The selected internet sites may desirably comprise registered websites considered to be suitable for users of the program 1 wishing to receive competitive prices or only items of quality meeting a high standard on goods and services. The searches conducted may utilise RSS feeds linked to such authorised and/or suitable websites.

In use, a user may be expected to receive updated details of goods/services for sale with the option to pursue purchase if desired. An advantage with this aspect of the program 1 is that a user would specify the goods/services required, and would then allow the searching functionality of the program 1 to provide user specific identification to search for information on particular goods and/or services specified by a user through the RSS feeds or otherwise, and the search means being adapted to communicate with an internet based search engine to locate such goods/services without undertaking manual searching. That way, the items desired would be shown to users when they are available, which may be particularly useful for more rare items such as vintage cars or stamps that may not be available for sale at the time a user has decided to purchase such items.

It is envisaged that the libraries of datafiles may be run continuously and without interruption for pre-screening purposes as required, and as such the program is therefore not limited in operation to display only when a wait event occurs. For example, a user can additionally request libraries of datafiles and select a datafile while waiting for wait events unknown to the personal computer, such as when a user is placed on hold during a telephone call.

The program of the invention is advantageously configured and arranged to allow a user to select and download a datafile and/or select a preference in the program to automatically or periodically download datafiles from a website server or other source for information and files.

The program may include the feature of selecting snippets of information sequentially from a datafile or randomly from the datafile, or sequentially or randomly from a number of datafiles, as desired.

It is envisaged that the displayed material may be introduced for display on a computer monitor as a gradual fade in and fade out image and/or displayed material may also gradually slide in and out from any screen position or by any other means for replacing one image or information with another image or further information.

It is further envisaged that the visual features of the information and audio datafiles may include any size and shape and colours, and even cartoons, whether static or animated, may be included in the program 1 with or without text.

It is further envisaged that audio may form a desirable function with the datafiles displayed or run as such audio can be desirable with language learning datafiles, movies or concert viewing or otherwise.

It is yet further envisaged that live streaming may form part of the program 1 being displayed in that when a wait event occurs, data from security cameras or from a remote webcam at any location can be streamed through to the computer and be displayed on screen. Such information may be cached and then displayed at the next available wait event. Further, live streaming may be provided from any desirable source such as, for example only, news from a news channel or stock market diagrams, charts, figures and details from a stock market firm.

User selectivity in step i. may involve prioritising subject matter and information such that the highest priority information cached will be displayed first, along with secondary information such as horoscopes being tagged as low priority, if desired. Such functionality means that a particular user of the program 1 can choose exactly the type of information they wish to view during wait events, and in what priority they wish to receive information.

It will be appreciated according to an aspect of the invention that the datafiles can be loaded onto any form of computer whether a desktop computer, portable computer or laptop, personal digital assistant (PDA), portable cellphone, or other useful and desirable device. It is considered that the program 1 may be encoded or encrypted to prevent the copying or reproduction or transfer of the static data files to another machine.

It is envisaged according to an alternative aspect of the invention that the datafiles may be loaded or run on a stand alone device, whether dedicated or incorporating other desirable features. In one non-limiting example only, the stand alone device may be integrated with a desk calendar and clock option and be portable in that it the device can be locatable beside a computer monitor. The stand alone device may have any desirable size of screen. Advantageously the stand alone device may be suitably interfaced with a computer as required. Various datafiles may be downloadable to the stand alone device, and can be changed and modified as desired. In operation, a start button can be activated to commence the operation of the program and with viewing snippets in the datafiles. A stop button can be also provided to end and/or suspend the operation. Other functions of the stand alone device can be as previously described with reference to the computer program 1.

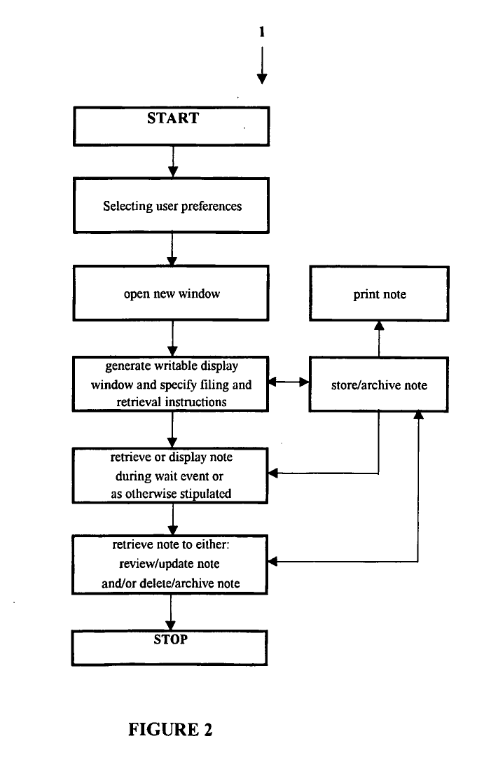

Referring now to FIG. 2, a flow chart of processing steps of a routine in the program 1 for use in generating notes or reminders, is now described.

An aspect of the program 1 allows a user to generate digital personal notes (“DPN”) and reminders for later display during a wait event, or as otherwise specified. This is different from other aspects of the invention in that instead of determining what information is to be obtained and displayed at certain times whether by RSS feed or otherwise, a user generates information and data, including generating reminders and notes and other such text in a display window, and stores such information for later viewing/reviewing or updating. Finally, the DPN or information generated may be either deleted/discarded or archived, as required.

In the case of appointment reminders, it is an aspect of the invention to include the option of a user being able to generate and upload information in the form of DPN or reminders as required. A hot key user sequence such as CTL+ALT+N may be configured and provided as an executable command to open a new display window. If a user requires more than one window they may do so, and may also work simultaneously or consecutively between the open display windows to write a plurality of reminders or DPN, and store them, as required. The DPN may be printed at any time after generation.

A display window can be suitably configured and arranged to show the time and date of creation of the note or reminder, category or folder name and the file directory, and such information uploaded is preferably saved, stored and retrieved in conveniently accessible folders and directories. The DPN or reminder can reappear in any manner, form and time as required by a user, and reappearance can be determined during generation of the DPN, including the program 1 being desirably configured to allow a user to select the time and date for later display of the particular DPN, and other filing and retrieval commands for the particular DPN or reminder generated.

It is envisaged that a user may be able to categorise the particular type of DPN, and select options for later retrieval, review and deletion. For example, a DPN may be in the form of a reminder to visit a dentist at a certain day and time. The program 1 can, after the DPN is generated, select the time and frequency of reappearance of the DPN. It may be automatically deleted when the assigned time period of the appointment has passed.

It is further considered that a library of such reminder datafiles can be generated reflecting different topics of interest for a user. For example, digital personal notes may reflect topics such as a work or personal project, errands, “to do” lists, ideas on a subject, and shopping lists. The folders or categories of personal notes may be assigned a particular background colour for ease of recognition of the type of information being displayed at a later time. A neutral tone may be applied for DPN's filed as reminders in chronological order. Appointment reminders and other such reminders tagged to a certain time may be automatically deleted if the time stipulated has passed.

The DPN and associated libraries are preferably fully retrievable for further review and updating. The reviewing mode desirably allows a user to scroll through the file of DPN's, and to either update or delete or archive such DPN, as required.

It will be appreciated according to an aspect of the invention that user preferences can be stipulated for determining the size and position of the display window on the desktop, and other user preferences as described with reference to FIG. 1. A default setting may be used so that the first window displays at a predetermined position, such as a corner of the desktop.

Wherein the aforegoing reference has been made to integers or components having known equivalents, then such equivalents are herein incorporated as if individually set forth. Accordingly, it will be appreciated that changes may be made to the above described embodiments of the invention without departing from the principles taught herein.

It is to be understood that the above description is intended to be illustrative, and not restrictive. Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the appended claims.

1-34. (canceled)

35. A method of loading preselected information data for display on a computer monitor by running a stand alone computer application program independently of other programs on a computer, the application program being configured to detect the occurrence of a wait event caused by at least one other program being run on the computer, the wait event resulting in a user having to wait for the computer to complete processing tasks commanded from one or more other programs being run on the computer, the method comprising:
A. detecting a wait event occurring in other programs being run on the computer by sensing a wait condition and loading a preselected information datafile, the detection of the wait event occurring independently of the other programs being run by the computer and not requiring any modification of the other programs;
B. displaying information from the selected information datafile on the computer monitor during the occurrence of the wait event; and
C. suspending display of information when the wait event has ended.

36. A method according to claim 35 further comprising the selection of any one or more of the following user preferences comprising: the type of information for display as a window and prioritising the display of different types of information; the duration or frequency of display of information; the number of said windows; the position and size of the windows; the contrast background of the windows; the transparency level of the background of the windows; and the colour of the windows.

37. A method according to claim 35 further comprising the selection of a corner anchor point that determines the position of the window for display on the desktop of the computer monitor screen, the selection of a position on the monitor results in the corner of the window closest to the position selected becoming the corner anchor point from which windows appear in a cluster.

38. A method according to claim 35 further comprising step D. of resuming display of the information datafile when a further wait event is detected.

39. A method according to claim 38 further comprising step E. of loading a second or subsequent information datafile for display after the first information datafile has been displayed or when the user chooses to load the second or the subsequent information datafile.

40. A method according to claim 36 further comprising a means for adjusting the display time in accordance with a user's reading speed and the length or amount of information to be displayed.

41. A method according to claim 35 comprising a means for selecting an information datafile for use as a teaching tool, the teaching tool means allowing a user to select preferences such as the subject matter; a set of questions and degree of difficulty with the subject matter; and the sequence of display of each said question and associated answer.

42. A method according to claim 35 comprising a means for obtaining information data in a form capable of being displayed on a monitor from a really simply syndication (RSS) feed obtained from a computer host server via a communications network and caching the information or data on a computer hard drive for presentation in a display window at a subsequent wait event.

43. A method according to claim 42 wherein the time interval between receipt of updated information from a RSS feed is automatically adjusted based on recent changes to content in the information being received by the RSS feed.

44. A method according to claim 42 wherein in step B. queries for details of updated information relating to the RSS feeds are regularly sent to internet based computer web servers, and such queries are monitored and the query rate is adjusted based on the threshold of intrusion on the network bandwidth applying to the computer.

45. A method according to claim 42 further comprises a means to search for information on particular goods and/or services specified by a user through the RSS feeds, and the search means being adapted to communicate with an internet based search engine.

46. A computer program for loading preselected information data for display on a computer monitor by running a stand alone computer application program independently of other programs on a computer, the application program being configured to detect the occurrence of a wait event caused by at least one other program being run on the computer, the wait event resulting in a user having to wait for the computer to complete processing tasks commanded from one or more other programs being run on the computer, the process comprising:
a. detecting a wait event occurring in other programs being run on the computer by sensing a wait condition and loading a preselected information datafile, the detection of the wait event occurring independently of the other programs being run by the computer and not requiring any modification of the other programs;
b. displaying information from the selected information datafile on the computer monitor during the occurrence of the wait event; and
c. suspending display of information when the wait event has ended.

47. A computer program according to claim 46 further comprising the preliminary step i. of allowing a user to select preferences from any one or more of the following user preferences comprising the type of information for display as a window; the duration of the window of information for display; the number of windows; the size of the window; the contrast background of the window; the transparency level of the background of the window; and the colour of the window.

48. A computer program according to claim 46 further comprising step d. of resuming display of the information datafile when a subsequent wait event is detected by way recommencing at the point where it was suspended at the end of the wait event, and continuing with step b. until step c. reoccurs.

49. A computer program according to claim 48 further including step e. of loading a second or subsequent information datafile for display after the first information datafile has been displayed or when the user chooses to end the first information datafile and load the second or subsequent information datafile.

50. A computer program according to claim 47 wherein the preliminary step i. includes preselecting any one or more information datafiles from a library of datafiles, the datafiles comprising information and/or text and/or graphics and/or audio material in a format suitable for display on a computer monitor.

51. A computer program according to claim 46 wherein in step b. the time period for display of information in a window before the next frame is shown is automatically adjusted given a user's reading speed and the amount of information being presented during a wait event.

52. A computer program according to claim 46 wherein the information provided for display in step b. is obtained from a RSS feed and cached on a computer hard drive for presentation in a display window at a subsequent wait event, and wherein the time interval between receipt of updated information from a RSS feed by a computer is automatically adjusted based on recent changes to content in the information being received by the RSS feed.

53. A computer program according to claim 46 wherein in step b. queries for details of updated information relating to the RSS feeds are regularly sent to internet based computer web servers, and such queries are monitored and the queries rate is adjusted based on the threshold of intrusion on the network bandwidth applying to the computer.

54. A computer program according to claim 46 further comprising a means to, search for information on particular goods and/or services specified by a user through the RSS feeds, and wherein the search means is adapted to communicate with an internet based search engine.

55. A computer program according to claim 47 wherein in step i. a user can select an origin point for anchoring a corner of the display window, the origin point of the display window being the corner of the display window that is nearest to a corner of the desktop of the computer monitor.

56. A computer program according to claim 46 wherein in step b. the information datafile includes information prepared as a sequence of questions and associated answers on a particular subject, and wherein a set of questions and answers on a subject form an information datafile.

57. A computer program according to claim 47 wherein the number of questions and/or the degree of difficulty of the questions and/or the sequence of display of each said question and associated answer from each said information datafile is selectable by a user.

58. A computer program according to claim 46 wherein each selected information datafile is displayed sequentially or randomly.

59. A computer program according to claim 46 wherein the window display is adapted as a personal notepad on a computer monitor to allow a user to upload data or information onto the personal notepad to generate a personal note, and the personal note is stored for later display at a predetermined future date and time as a reminder, or displayed during a wait event.

60. A computer program according to claim 59 wherein each said personal note generated is assigned a file category, and each said personal note and each said file category is retrievable and updateable.

61. A computer program according to claim 59 wherein each said file category is assigned a different colour to distinguish one category of said personal note from another category.

62. A computer program according to claim 46 wherein in step i. the program is adapted to allow a user to encrypt and lock access to selected information datafiles and RSS feeds only to authorised users of such information datafiles.

63. A method according to claim 35 wherein the preselected information data is obtained and stored ready for display when required, and wherein a user manually runs the program to display the preselected information at any desirable time.

64. A method according to claim 35 wherein the stand alone computer application program is not embedded in the other programs for which wait events are being detected.

65. A method according to claim 35 wherein in step A., the wait condition is detected by sensing any one or more of the following activities, the activities being a trigger sent from another program to the operating system of the computer or a change in a cursor status or by a change in the activity state of an application-specific icon.

66. A method according to claim 35 wherein in step A, the wait condition is detected by sensing any one or more of at least two activities.

67. A method according to claim 35 wherein in step A, the wait condition is detected by sensing any one or more of three activities.

68. A computer program according to claim 46 wherein the stand alone computer application program is not embedded in the other programs for which wait events are being detected.
